(19) United States
(12) Patent Application Publication
(10) Pub. No.: US 2004/0196244 A1
(43) Pub. Date: Oct. 7, 2004

(54) Display system and driving method thereof

(76) Inventor: Jiing Lin, Hsin-Tien City (TW)

Correspondence Address: NAIPO (NORTH AMERICA INTERNATIONAL PATENT OFFICE), P.O. BOX 506, MERRIFIELD, VA, 22116, US

(21) Appl. No.: 10/462,651

(22) Filed: Jun. 17, 2003

(30) Foreign Application Priority Data
Apr. 4, 2003 (TW) 092107817

(51) Int. Cl. G09G 3/36

(52) U.S. Cl. 345/98

(57) ABSTRACT

A display system and a driving method thereof. The display system has a display panel, a storage device, a frame buffer, a display controller, a driving circuit, and a digital-to-analog converter. The storage device is used to store display data corresponding to a plurality of pixels of the display panel. The display controller generates the display data and stores the display data in the frame buffer. When data stored in a second memory unit of the frame buffer are different from data stored in a first memory unit of the storage device, the display controller transmits data stored in the second memory unit toward the driving circuit for using the driving circuit to update data stored in the first memory unit. In addition, the digital-to-analog converter then immediately drives a corresponding pixel according to the updated data of the first memory unit.

### BACKGROUND OF INVENTION

1. Field of the Invention

The present invention relates to a display system and a driving method thereof. More specifically, the present invention discloses a liquid crystal display (LCD) monitor having a storage device to store display data and a related method for driving the LCD monitor.

2. Description of the Prior Art

Generally speaking, the liquid crystal display (LCD) monitor has many virtues such as having lighter weight, producing lower power dissipation, outputting less radiation, etc. Therefore, the LCD monitor has been widely used on many kinds of portable information devices. For example, the notebooks and personal digital assistants adopt LCD monitors to show text and images. In addition, the LCD monitor gradually takes place of a cathode ray tube (CRT) monitor used by a desktop computer. With regard to the LCD monitor, when alignment of the liquid crystal molecules is changed, an incident light is then affected by the liquid crystal molecules to be polarized or refracted according to the altered alignment. Therefore, the LCD monitor makes use of the physical characteristic of the liquid crystal molecules to produce three monochromatic lights (red light, blue light, and green light) with different gray levels. Then, colorful images are displayed.

Please refer to FIG. 1, which is a diagram of a first prior art display system 10. The display system 10 has a host 12 and an LCD monitor 22. The host 12 includes a central processing unit (CPU) 14, a north bridge circuit 16, a graphics card 17, and a main memory 20. The LCD monitor 22 includes an LCD panel 24 and a driving circuit 26. For the host 12, the CPU 14 is used to control overall operation of the host 12. The north bridge circuit 16 is used to control signal transmission between high-speed peripheral devices (the graphics card 17 and the main memory 20 for example) and the CPU 14. For instance, the north bridge circuit 16 performs data format conversion to make data outputted from the graphics card 17 be correctly inputted into the CPU 14, or the north bridge circuit 16 performs data format conversion to make data stored in the main memory 20 be successfully transferred to the graphics card 17. In addition, the graphics card 17 has a display controller 18 and a frame buffer 19. The display controller 18 is used to drive the LCD monitor 22 and performs 2D and 3D graphics processing. The frame buffer 19 is used to store display data required to drive the LCD monitor 22, or is capable of temporarily storing calculation results produced from the graphics card 17 performing 2D and 3D graphics processing. A plurality of pixels 25 are disposed on the LCD panel 24. The pixels 25 are arranged according to a matrix format. It is well-known that each pixel 25 functions as a capacitor. That is, the pixel 25 is charged or discharged to alter its voltage difference (a so-called gray level). Then, the objective of displaying images is achieved. The driving circuit 26 drives the gray level associated with each pixel 25 based on a horizontal synchronization signal H-SYNC, a vertical synchronization signal V-SYNC, and display data DATA generated from the graphics card 17. For example, when the driving circuit 26 selects all pixels 25 located at an n^{th} row according to the received horizontal synchronization signal H-SYNC, the driving circuit 26 then sequentially sets a gray level associated with each pixel 25 located at the same n^{th} row according to the received vertical synchronization signal V-SYNC and the received display data DATA.

After gray levels of the pixels 25 located at the n^{th} row are successfully assigned, the driving circuit 26 starts selecting all pixels 25 located at an (n+1)^{th} row according to the received horizontal synchronization signal H-SYNC. Similarly, the driving circuit 26 sequentially sets a gray level associated with each pixel 25 located at the same (n+1)^{th} row according to the received vertical synchronization signal V-SYNC and the received display data DATA. The driving circuit 26 repeats the above-mentioned operation to sequentially update gray levels of the pixels 25 row by row. Therefore, with the well-known “persistence of vision” phenomenon, the driving circuit 26 continuously updates image frames shown on the LCD panel 24 to make display data DATA be smoothly displayed in front of an user. The speed of updating image frames shown on the LCD panel 24 is a so-called refresh rate.

As mentioned above, when the prior art display system 10 displays an image on the LCD monitor 22, the display system 10 has to repeatedly transfer display data to the driving circuit 26 in the LCD monitor 22 so that the driving circuit 26 can drive the gray levels of the pixels to exactly correspond to the display data DATA. Therefore, the display quality of the LCD monitor 22 is not deteriorated under certain refresh rate (75 Hz for example). However, the display data DATA are stored in the frame buffer 19. The display controller 18 needs to continuously access the frame buffer 19 to retrieve the wanted display data DATA and then is capable of transferring the retrieved display data DATA to the driving circuit 26 successively. As mentioned above, the frame buffer 19 not only stores the display data DATA, but also functions as a buffer to store calculation results generated from the display controller 18 performing graphics processing. Therefore, suppose that a data transmission bandwidth between the display controller 18 and the frame buffer 19 corresponds to a fixed value. Part of the data transmission bandwidth is occupied while the display controller 18 retrieves the display data DATA. It is obvious that available data transmission bandwidth is reduced while the display controller 18 performs graphics processing. In other words, performance of the display controller 18 is then greatly worsened.

For instance, suppose that a resolution of the LCD panel 24 is set to be 800*600, and the adopted refresh rate is equal to 75 Hz. If the display data DATA uses six bits to represent a gray level associated with one pixel 25, the occupied data transmission bandwidth is roughly equal to 25 megabytes (MB) per second while the display controller 18 retrieves the display data DATA. Moreover, if the LCD monitor 22 is a color display monitor, the occupied data transmission bandwidth becomes 75 MB per second. It is well-known that access of the display data DATA corresponds to a highest priority so as to successfully maintain the display quality. But, the display system 10, as mentioned above, has a limited data transmission bandwidth. Therefore, when the display controller 18 actuates graphics processing, access of the display data DATA stored in the frame buffer 19 will correspondingly interfere with access of the calculation results stored in the same frame buffer 19 because these data access operations together share the limited data transmission bandwidth.

Please refer to FIG. 2, which is a diagram of a second prior art display system 30. The display system 30 has a host 32 and a LCD monitor 42. The host 32 includes a CPU 34, a north bridge circuit 36, and a main memory 40. The LCD monitor 42 includes an LCD panel 44 and a driving circuit 46. There are a plurality of pixels 45 disposed on the LCD panel 44, and the pixels 45 are arranged according to a matrix format. Please note that the elements with the same name correspond to identical functionality and operation. Therefore, the lengthy description is not repeated for simplicity. The only difference is that a display controller 38 is integrated in the north bridge circuit 36 of the display system 30. The display controller 38 is used to replace the graphics card 17 shown in FIG. 1 for driving the LCD monitor 42. In addition, the display controller 38 uses the main memory 40 as its frame buffer. Similarly, when the display system 30 shows an image on the LCD monitor 42, the display system 30 needs to repeatedly transfer display data DATA to the driving circuit 46 of the LCD monitor 42 so that the driving circuit 46 is capable of controlling gray levels of the pixels 45 to correspond to the display data DATA. However, with regard to the display system 30, the display data DATA are stored in the main memory 40. Therefore, the display controller 38 needs to continuously access the main memory 40 for retrieving the wanted display data DATA, and then transmits the retrieved display data DATA to the driving circuit 46.

As described above, a data transmission bandwidth with a limited capacity is allocated between the north bridge circuit 36 and the main memory 40. Therefore, if the display controller 38 retrieves the display data DATA, this access operation certainly occupies part of the data transmission bandwidth. On the other hand, the available data transmission bandwidth is reduced so that other data processing procedures associated with the main memory 40 are affected. In other words, performance of the host 32 is then worsened.

### SUMMARY OF INVENTION

It is therefore a primary objective of this invention to provide a display system with a liquid crystal display (LCD) monitor having a storage device to hold display data. Briefly summarized, the claimed invention discloses a display device comprising a display panel, a storage device, a driving circuit, and a digital-to-analog converter. The display panel is used to display an image, and the display panel has a plurality of pixels arranged according to a matrix format. The storage device is electrically connected to the display panel, and the storage device has a plurality of memory units. Each of the memory units respectively corresponds to a pixel disposed on the display panel. The driving circuit is electrically connected to the storage device for updating data stored in the memory units according to address data and display data. The digital-to-analog converter is electrically connected to the storage device and the display panel for driving the pixels associated with the memory units. The claimed invention also discloses a display system comprising a display panel, a storage device, a frame buffer, a display controller, a driving circuit, and a digital-to-analog converter. The display panel is used to display an image, and the display panel has a plurality of pixels arranged according to a matrix format. The storage device is electrically connected to the display panel, and the storage device has a plurality of first memory units for storing data corresponding to the pixels of the display panel. The frame buffer has a plurality of second memory units corresponding to the first memory units. The display controller is used to output data of a second memory unit when data of the second memory unit is different from data of a first memory unit corresponding to the second memory unit. The driving circuit is electrically connected to the display controller and the storage device for updating data of the first memory unit according to data of the corresponding second memory unit outputted from the display controller. The digital-to-analog converter is electrically connected to the storage device and the display panel for converting data of the first memory units into corresponding driving voltages to drive pixels corresponding to the first memory units. The claimed invention further discloses a method for driving a display system. The display system has a display device and a computer host. The display device has a display panel and a plurality of first memory units. The first memory units storing data are used to drive the display panel. The computer host has a plurality of second memory units respectively correspond to the first memory units for receiving and storing display data. The method includes holding data stored in a first memory unit and utilizing data stored in the first memory unit to successively drive the display panel to display a plurality of image frames, and if display data stored in a second memory unit is different from data stored in the first memory unit, utilizing the display data stored in the second memory unit to update data stored in the first memory unit.

It is an advantage of the claimed invention that the claimed display system lowers usage of the limited data transmission bandwidth without repeatedly updating display data associated with the corresponding pixel by the identical display data.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a first prior art display system.

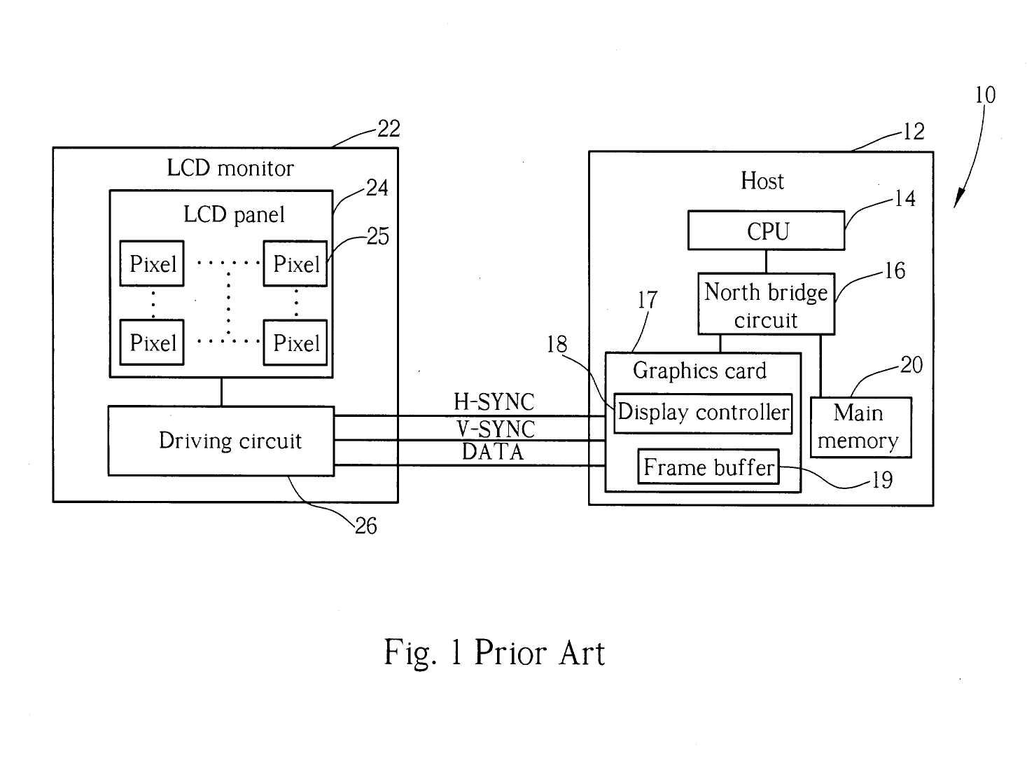

FIG. 2 is a diagram of a second prior art display system.

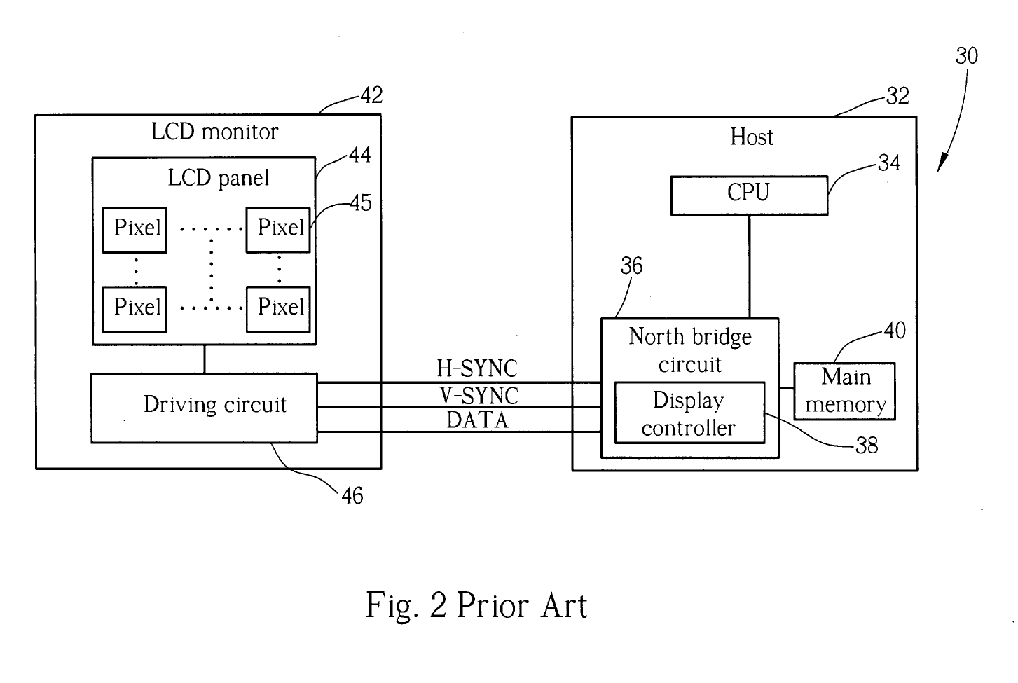

FIG. 3 is a diagram of a first display system according to the present invention.

FIG. 4 is a timing diagram illustrating driving of the display system shown in FIG. 3.

FIG. 5 is a diagram of a second display system according to the present invention.

### DETAILED DESCRIPTION

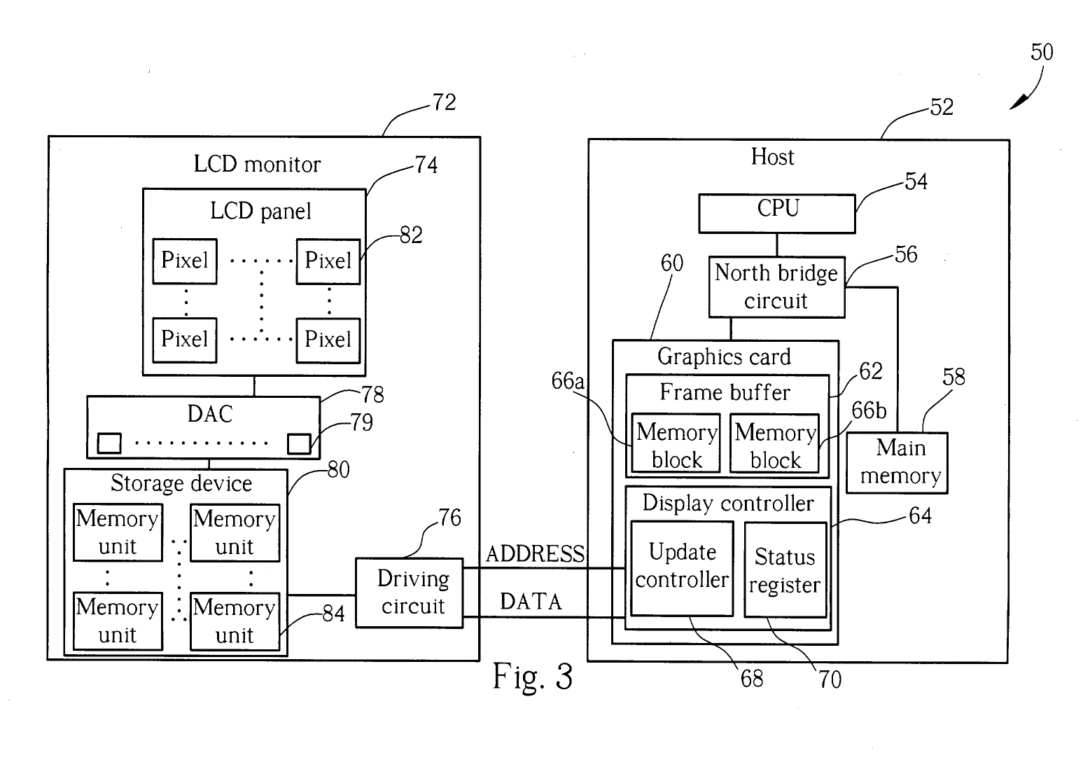

Please refer to FIG. 3, which is a diagram of a first display system 50 according to the present invention. The display system 50 has a host 52 and an LCD monitor 72. The host 52 includes a CPU 54, a north bridge circuit 56, a main memory 58, and a graphics card 60. The graphics card 60 has a frame buffer 62 and a display controller 64. In addition, two memory blocks 66a, 66b are disposed within the frame buffer 62, and an update controller 68 and a status register 70 are disposed within the display controller 64. Each of the memory blocks 66a, 66b has a plurality of memory units (so-called memory cells) for storing data. The LCD monitor 72 includes an LCD panel 74, a driving circuit 76, a digital-to-analog converter (DAC) 78, and a storage device 80. A plurality of pixels 82 are disposed on the LCD panel 74, and are arranged according to a matrix format. The storage device 80 has a plurality of memory units 84. Each memory unit 84 individually corresponds to a specific pixel 82. The CPU 54 is used to control overall operation of the display system 50. The north bridge circuit 56 is used to control signal transmission between the CPU 64 and high-speed peripheral devices such as the graphics card 60 and the main memory 58. For example, the north bridge circuit 56 is capable of converting one data format associated with the data generated from the graphics card 60 into another data format recognized by the CPU 54 so that the data outputted from the graphics card 60 are successfully transmitted to the CPU 54. Similarly, the data stored in the main memory 58 are successfully transferred to the graphics card 60 with the help of the north bridge circuit 56. The graphics card 60 is used to drive the LCD monitor 72. That is, gray levels associated with pixels 82 disposed on the LCD panel 74 are set by the graphics card 60 to display a corresponding image on the LCD panel 74.

In the preferred embodiment, the memory block 66a of the frame buffer 62 is used to store display data associated with the image shown on the LCD panel 74. On the other hand, the memory block 66b of the frame buffer 62 functions as a buffer to store calculation results generated from the display controller 62 performing graphics processing. The status register 70 of the display controller 64 is used to record information used to determine if display data stored by the memory block 66a are modified for two successive frames. For example, the status register 70 has n status bits, and each status bit individually corresponds to display data stored by the memory block 66a that are associated with a specific pixel. Therefore, when the display data associated with the specific pixel are modified for two successive frames, that is, the specific pixel corresponds to different gray levels, the corresponding status bit in the status register 70 makes a logic value transition to alter a logic value stored by the status bit.

Then, the update controller 68 detects each status bit of the status register 70. If a first status bit has a logic value transition, the update controller 68 controls the display data DATA stored in the memory block 66a, which correspond to a first pixel and the first status bit, to be transmitted to the driving circuit 76. In the preferred embodiment, each memory unit 84 corresponds to a specific pixel 82. Therefore, the update controller 68 also transmits address data ADDRESS of a first memory unit corresponding to the first pixel to the driving circuit 76. The driving circuit 76 then updates the memory unit 84 based on the received address data ADDRESS and the received display data DATA. In other words, each memory unit 84 records the gray level associated with a corresponding pixel 82. The DAC 78 is used to convert a digital signal into a corresponding analog signal, that is, a driving voltage. The DAC 78 includes a plurality of DAC units 79 respectively correspond to memory units 84. Therefore, the DAC unit 79 converts the digital display data (gray level) into a driving voltage to drive a corresponding pixel 82. It is noteworthy that each memory unit 84 in the storage device 80 is electrically connected to a corresponding pixel 82 through the DAC unit 79. Therefore, the digital display data recorded by the memory unit 84 persistently drives the electrically connected pixel 82 through the DAC unit 79 to display the corresponding gray level. That is, if the display data recorded by the memory unit 84 are modified, the gray level associated with the pixel 82 is adjusted immediately.

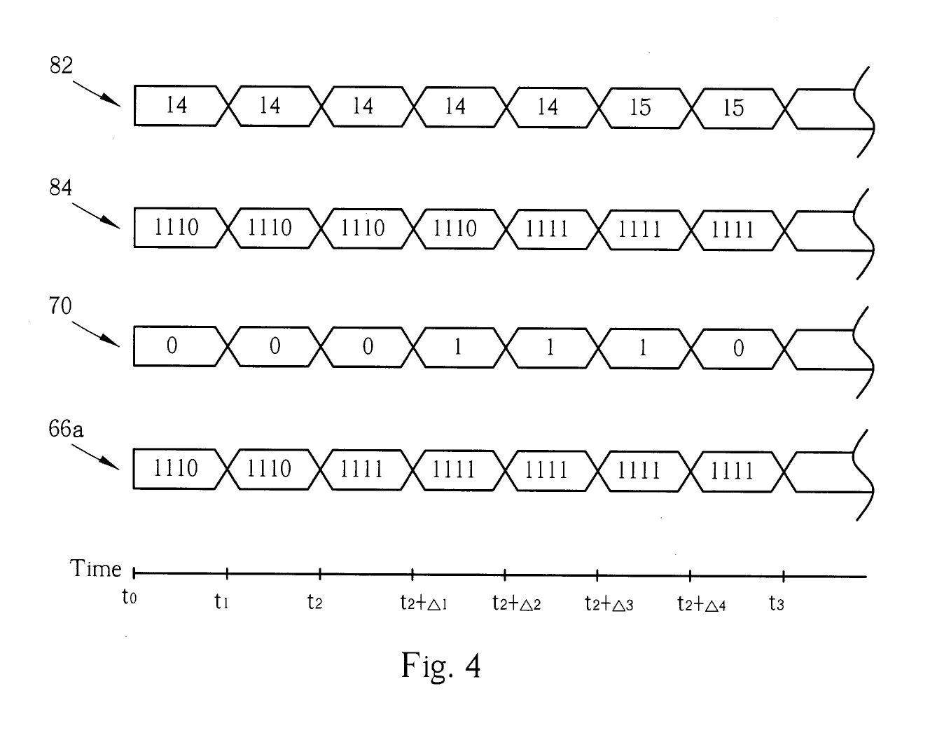

Operation of above display system 50 is described as follows. Please refer to FIG. 4 in conjunction with FIG. 3. FIG. 4 is a timing diagram illustrating driving of the display system 50 shown in FIG. 3. Information associated with the pixel 82, the memory unit 84, the status register 70, the memory block 66a, and time is shown from top to bottom. For simplicity, only a pixel 82, the memory unit 84 corresponding to the pixel 82, a status bit of the status register 70 corresponding to the pixel 82, and display data in the memory block 66a corresponding to the pixel 82 are used to describe operation of the display system 50 without affecting disclosure of the present invention. Suppose that gray level of the pixel 82 is represented by four bits. Therefore, the decimal gray level available to the pixel 82 ranges from 0 to 15, wherein each gray level stands for a predetermined driving voltage generated by the DAC 78. At time t0 (a first frame), a memory unit in the memory block records display data “1110” corresponding to the pixel 82, and the status bit in the status register 70 records a logic value “0”. The memory unit 84 corresponding to the pixel 82 also records the display data “1110”. Therefore, the gray level outputted by the pixel 82 is equal to “14” according to the binary display data “1110”.

At time t1 (a second frame), the display controller 64 still sets the gray level associated with the pixel 82 to equal “14” after a predetermined graphics processing is performed. That is, the display data stored in the memory block 66a are “1110”. With regard to the display data stored in the memory block 66a, the display data corresponding to the pixel 82, therefore, are not modified. In other words, the corresponding status bit in the status register 70 still records the logic value “0”. As mentioned above, the update controller 68 determines that display data kept by the memory unit 84 does not need to be updated according to the logic value stored by the status bit of the status register 70. Therefore, the memory unit 84 still records the display data “1110” originally stored at time t0. At the same time, the DAC unit 79 drives the pixel 82 to correspond to the gray level “14” according to the display data “1110” stored by the memory unit 84.

At time t2 (a third frame), the display controller 64 modifies the gray level associated with the pixel 82 to be “15” after performing a predetermined graphics processing. That is, the memory unit in the memory block 66a now records binary display data “1111”. Therefore, display data associated with the pixel 82 are varied in the second frame and the third frame. The corresponding status bit in the status register 70 has a logic value transition at time t2+Δ1 to point out that display data stored in the memory block 66a are modified. That is, the corresponding status bit in the status register 70 stores the logic value “1” instead. Now, the update controller 68 reads the status register 70, and finds out that the status register 70 has one status bit recording the logic value “1”. Then, the update controller 68 transmits display data DATA (“1111”) stored in the memory unit of the memory block 66a and the address data ADDRESS associated with the corresponding memory unit 84 to the driving circuit 76. Then, the driving circuit 76 uses the newly received display data DATA (“1111”) and the address data ADDRESS to update the display data “1110” originally stored in the memory unit 84 at time t2+Δ2. In other words, the memory unit 84 records the display data “1111” at time t2+Δ2. In addition, the DAC unit 79 immediately drives the pixel 82 to correspond to the gray level “15” at time t2+Δ3 according to the display data “1111” currently stored in the memory unit 84.

After the gray level associated with the pixel 82 is successfully updated, the driving circuit 76 informs the display controller 64 of the accomplishment of the above update operation. At time t2+Δ4, the status register 70, therefore, is reset to record the logic value “0”. It means that display data respectively stored in the memory block 66a and the memory unit 84 are matched and are synchronized. The display system 50 repeats the above-mentioned operation after time t3. To sum up, if the display data in the memory block 66a are modified, the display system 50 actuates the update controller 68 to control the driving circuit 76 to update the corresponding memory unit 84. Eventually, both of the memory block 66a and the storage device 80 store the same display data.

Please note that if display data associated with any pixel 82 are modified, the above-mentioned process is capable of finishing updating the corresponding memory unit 84. In the preferred embodiment, if display data associated with one pixel 82 are not altered, the display controller 64 does not need to retrieve corresponding display data stored in the memory block 66a to update the memory unit 84. The DAC unit 79 reads the display data of the memory unit 84 synchronized with the memory block 66a to drive the pixel 82 to maintain a gray level originally shown by the pixel 82. That is, the pixel 82 is continuously driven by the DAC unit 79 to show a fixed gray level unless the display data associated with the pixel 82 are modified. The display controller 64 in the preferred embodiment needs to access corresponding display data, and occupies part of the data transmission bandwidth between the display controller 64 and the frame buffer 62 only when the gray level of the pixel 82 corresponds to different values in two successive frames. Compared with the prior art, the display controller 64 has much available data transmission bandwidth to efficiently access the memory block 66b when performing 2D or 3D graphics processing. In other words, the graphics card 60 has better performance.

In the preferred embodiment, the status register 70 is a static random access memory (SRAM). However, any types of storage devices can be used to implement the status register 70. As shown in FIG. 4, when the storage device 80 and the frame buffer 62 are not synchronized to record the same display data associated with a pixel, one corresponding bit, which is called a status bit, in the status register 70 stores a binary value transited from one logic value “0” to another logic value “1” for recording the above non-synchronization status. However, it is obvious that the corresponding bit in the status register 70 can also store a binary value transited from one logic value “1” to another logic value “0” for recording the above non-synchronization status. That is, the status register 70 records the logic value “1” instead to point out that storage device 80 and the frame buffer 62 are synchronized to keep identical display data associated with one pixel.

In addition, the storage device 80 is a non-volatile memory such as a flash memory. However, a volatile memory can also be used to implement the storage device 80. For example, if the storage device 80 is a dynamic random access memory (DRAM), the LCD monitor 72 needs to have a refresh circuit electrically connected to the storage device 80. The refresh circuit is used to periodically refresh data kept in the memory units 84 so that the stored data will not be lost. Moreover, it is well-known that the LCD panel 74 is fabricated through a semiconductor process. For instance, a prior art thin film transistor (TFT) LCD panel has a plurality of TFTs respectively corresponding to pixels 82 located on the LCD panel 74. In addition, the storage device 80 and the DAC 78 can be fabricated through a semiconductor process. In the preferred embodiment, the storage device 80 and the DAC 78, therefore, can be integrated with the LCD panel 74. In other words, each pixel 82 individually includes a memory unit 84 and a DAC unit 79. For example, each memory unit 82 is built by flip-flops to store display data represented by n bits. Then, the DAC 78 is capable of converting the display data represented by n bits into a corresponding driving voltage.

In the preferred embodiment, a plurality of DAC units 79 are disposed within the DAC 78. Each DAC unit 79 is connected between one memory unit 84 and a corresponding pixel 82. Therefore, when the display data recorded by the memory unit 84 are modified, the DAC unit 79 immediately changes the gray level shown by the pixel 82 according to the display data currently stored in the memory unit 84. However, in the display system 50 according to the present invention, the DAC 78 can also have only one DAC unit 79 to sequentially drive all of the pixels 82. That is, the prior art driving scheme for the CRT monitor is then adopted. For instance, during a first period, the DAC unit 79 reads an nth memory unit 84 to drive an n^{th} pixel 82. During a second period following the first period, the DAC unit 79 reads a (n+1)^{th} memory unit 84 to drive a (n+1)^{th} pixel 82. Therefore, the same DAC unit 79 drives the pixels 82 on the LCD panel 74 one by one to control the LCD panel 74 to correctly display images.

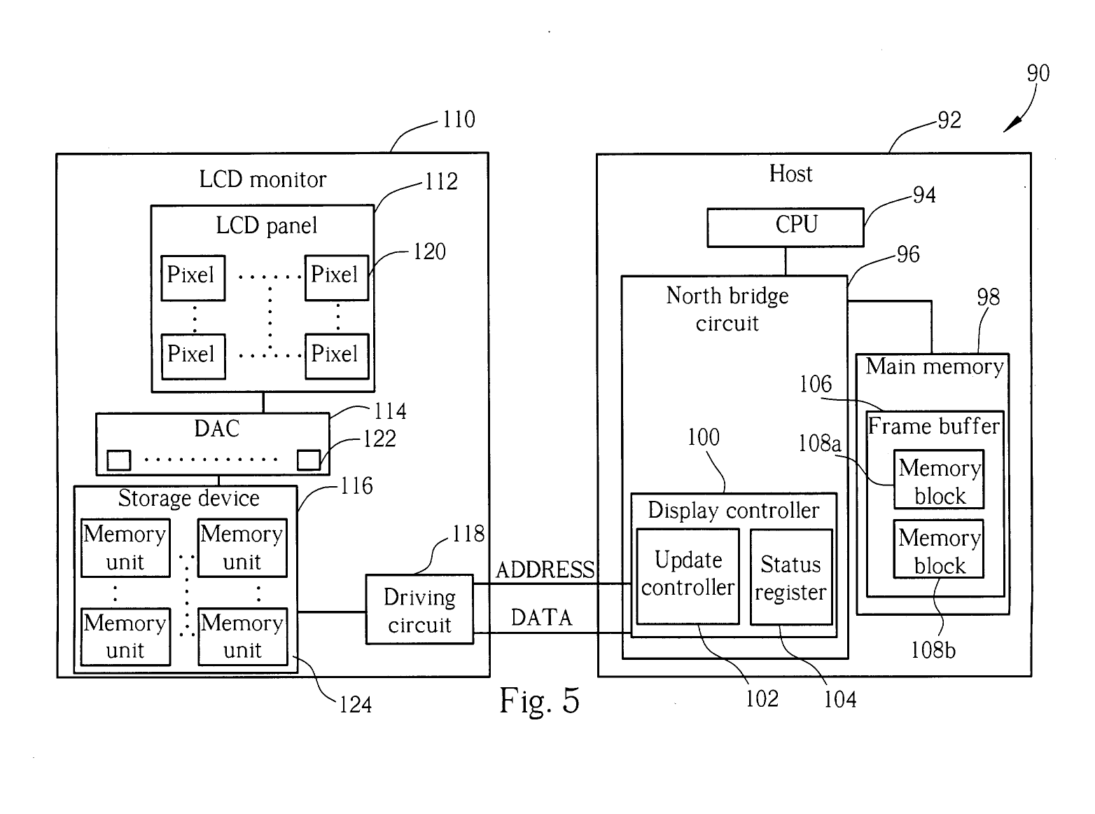

Please refer to FIG. 5, which is a diagram of a second display system 90 according to the present invention. The display system 90 has a host 92 and an LCD monitor 110. The host 92 includes a CPU 94, a north bridge circuit 96, and a main memory 98. The LCD monitor 110 includes an LCD panel 112, a DAC 114, a storage device 116, and a driving circuit 118. In addition, the LCD panel 112 includes a plurality of pixels 120 arranged according to a matrix format, the DAC 114 has a plurality of DAC units 122, and the storage device 116 has a plurality of memory units 124. With regard to the host 92, the north bridge circuit 96 has a display controller 100, and the display controller 100 includes an update controller 102 and a status register 104. The main memory 98 includes a frame buffer 106, wherein two memory blocks 108a, 108b are disposed in the frame buffer 106. In the preferred embodiment, the memory block 108a of the frame buffer 106 is used to store display data associated with an image displayed on the LCD panel 112, and the memory block 108b of the frame buffer 106 functions as a buffer used to store calculation results outputted from the display controller 100 performing graphics processing. Elements with the same name in the second display system 90 and the first display system 50 correspond to the same functionality and operation. Therefore, the lengthy description for the elements is not repeated for simplicity.

The major difference between the second display system 90 and the first display system 50 is that the north bridge circuit 96 of the display system 90 integrates functionality of the display controller 64 and the north bridge circuit 56 within the display system 50. For instance, the display controller 64 shown in FIG. 3 is a graphics chip disposed on the graphics card 60. However, the display controller 100 shown in FIG. 5 is a graphics chip disposed in the north bridge circuit 96. In addition, a memory capacity, that is the frame buffer 106, is divided from the main memory 98 to function as the frame buffer 62 of the display system 50 shown in FIG. 3. In other words, the display controller 100 has to access the main memory 98 to further access the memory block 108a storing display data and the memory block 108b storing calculation results. Operation run by the display system 90 to drive the LCD monitor 110 is identical to that run by the display system 50. That is, the elements with the same name in the display systems 50, 90 operate according to the timing shown in FIG. 4.

Therefore, if display data associated with a pixel 120 are not modified, the display controller 100 in the preferred embodiment does not need to retrieve corresponding data stored in the memory block 108a to update the memory unit 124 corresponding to the pixel 120. The DAC unit 122 reads the display data recorded by the memory unit 124 synchronized with the memory block 108a to drive the pixel 120 to consistently show the unchanged gray level. That is, the DAC unit 122 continuously drives the pixel 120 to show a fixed gray level unless the display data recorded in the memory unit 124 are altered. The display controller 100 in the preferred embodiment needs to access corresponding display data stored in the memory block 108a, and occupies part of the data transmission bandwidth between the display controller 100 and the frame buffer 98 only when the gray level of the pixel 120 corresponds to different values in two successive frames. Compared with the prior art, the display controller 100 has much available data transmission bandwidth to efficiently access the memory block 108b when performing 2D or 3D graphics processing. In other words, the display system 90 has better performance.

In the preferred embodiment, the status register 104 is a static random access memory (SRAM). However, any types of storage devices can be used to implement the status register 104. In addition, the storage device 116 is a non-volatile memory such as a flash memory. However, a volatile memory can also be used to implement the storage device 116. For example, if the storage device 116 is a dynamic random access memory (DRAM), the LCD monitor 110 needs to have a refresh circuit electrically connected to the storage device 116. The refresh circuit is used to periodically refresh data kept in the memory units 84 so that the stored data will not be lost. Moreover, it is well-known that the LCD panel 112 is fabricated through a semiconductor process. For instance, a prior art thin film transistor (TFT) LCD panel has a plurality of TFTs respectively corresponding to pixels 120 located on the LCD panel 112. In addition, the storage device 116 and the DAC 114 can be fabricated through a semiconductor process as well. In the preferred embodiment, the storage device 116 and the DAC 114, therefore, can be integrated with the LCD panel 112. In other words, each pixel 120 is fabricated through the same semiconductor process, and individually includes a memory unit 124 and a DAC unit 122.

For example, each memory unit 124 is built by flip-flops to store display data represented by n bits. Then, the DAC unit 122 is capable of converting the display data represented by n bits into a corresponding driving voltage. In the preferred embodiment, a plurality of DAC units 122 are disposed within the DAC 114. Each DAC unit 122 is connected between one memory unit 124 and a corresponding pixel 120. Therefore, when the display data recorded by the memory unit 124 are modified, the DAC unit 122 immediately changes the gray level shown by the pixel 120 according to the display data currently stored in the memory unit 124. However, in the display system 90 according to the present invention, the DAC 114 can also has only one DAC unit 122 to sequentially drive all of the pixels 120. That is, the prior art driving scheme for the CRT monitor is then adopted. For instance, during a first period, the DAC unit 122 reads an n^{th} memory unit 124 to drive an nth pixel 120. During a second period following the first period, the DAC unit 122 reads a (n+1)^{th} memory unit 124 to drive a (n+1)^{th} pixel 120. Therefore, the same DAC unit 122 drives the pixels 120 on the LCD panel 112 one by one to control the LCD panel 112 to correctly display images.

In contrast to the prior art, the claimed display system has an update controller and a status register disposed in a display controller, and a storage device and a digital-to-analog converter are disposed on an LCD monitor. With the help of the status register and the update controller, display data stored in a frame buffer are synchronized with display data stored in the storage device. When the display data in the frame buffer are different from the display data in the storage device, the display controller starts occupying part of data transmission bandwidth associated with the frame buffer to update the display data. The claimed display system lowers usage of the limited data transmission bandwidth without repeatedly updating display data associated with the corresponding pixel by the identical display data.

With regard to the prior art display system, the prior art display system occupies much data transmission bandwidth to unceasingly transfer display data used to maintain images displayed on the LCD monitor. Therefore, performance of the display controller is affected when the display controller wants to access the frame buffer to perform related graphics processing. In other words, no matter what the gray level to which a corresponding pixel corresponds in two successive frames, the prior art display system must uses the display controller to continuously retrieve display data in the frame buffer for driving pixels in every frames. That is, if one pixel corresponds to an identical gray level in two successive frames, the prior art display system retrieves the display data to drive the corresponding pixel in a first frame. Similarly, the prior art display system repeatedly retrieves the same display data to drive the corresponding pixel in a second frame. The available data transmission bandwidth associated with the frame buffer is then greatly occupied.

However, concerning the claimed display system, suppose that one pixel corresponds to an identical gray level in two successive frames. The claimed display system makes use of the storage device and the DAC on the LCD monitor to drive the corresponding pixel when showing a first frame. When the claimed display system shows a second frame, the display controller does not need to access frame buffer. The storage device and the DAC on the LCD monitor are capable of continuously maintaining the same gray level. Therefore, the data transmission bandwidth associated with the frame buffer is prevented from being greatly occupied. To sum up, the claimed display system can improve performance of graphics processing without affecting display quality.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A display device comprising:
a display panel for displaying an image, the display panel comprising a plurality of pixels arranged according to a matrix format;
a storage device electrically connected to the display panel, the storage device comprising a plurality of memory units, each of the memory units respectively corresponding to a pixel disposed on the display panel;
a driving circuit electrically connected to the storage device for updating data stored in the memory units according to address data and display data; and
a digital-to-analog converter (DAC) electrically connected between the storage device and the display panel for converting data of the memory units into corresponding driving voltages to drive the pixels associated with the memory units.

2. The display device of claim 1 wherein the DAC comprises a plurality of DAC units, and each of the DAC units is respectively connected to a memory unit of the storage device.

3. The display device of claim 1 wherein the storage device is a volatile memory, and the display device further comprises a refresh circuit for periodically refreshing data stored in each of the memory units of the storage device.

4. The display device of claim 3 wherein the volatile memory is a dynamic random access memory (DRAM).

5. The display device of claim 1 wherein the storage device is a non-volatile memory.

6. The display device of claim 5 wherein the non-volatile memory is a flash memory.

7. A display system comprising:
a display panel for displaying an image, the display panel comprising a plurality of pixels arranged according to a matrix format;
a storage device electrically connected to the display panel, the storage device comprising a plurality of first memory units for storing data corresponding to the pixels of the display panel;
a frame buffer comprising a plurality of second memory units respectively corresponding to the first memory units;
a display controller for outputting data of a second memory unit when data of the second memory unit is different from data of a first memory unit corresponding to the second memory unit;
a driving circuit electrically connected between the display controller and the storage device for updating data of the first memory unit according to data of the corresponding second memory unit received from the display controller; and
a digital-to-analog converter (DAC) electrically connected between the storage device and the display panel for converting data of the first memory units into corresponding driving voltages to drive pixels corresponding to the first memory units.

8. The display system of claim 7 wherein the storage device is a volatile memory, and the display system further comprises a refresh circuit for periodically refreshing data stored in each of the first memory units.

9. The display system of claim 8 wherein the volatile memory is a dynamic random access memory (DRAM).

10. The display system of claim 7 wherein the storage device is a non-volatile memory.

11. The display system of claim 10 wherein the non-volatile memory is a flash memory.

12. The display system of claim 7 wherein the display controller is a graphics chip.

13. The display system of claim 12 wherein the graphics chip is disposed on a graphics card.

14. The display system of claim 13 wherein the frame buffer is disposed on the graphics card.

15. The display system of claim 12 wherein the graphics chip is disposed within a north bridge circuit.

16. The display system of claim 7 wherein the display panel is a liquid crystal display (LCD) panel.

17. The display system of claim 7 wherein the display controller comprises:
a status register comprising a plurality of status bits respectively corresponding to the first memory units and the second memory units for indicating whether data stored in the first memory units are identical to data stored in the corresponding second memory units; and
an update controller electrically connected to the status register and the driving circuit for selectively transmitting data of a second memory unit to the driving circuit according to data stored in a register bit corresponding to the second memory unit.

18. The display system of claim 17 wherein the status register is a static random access memory (SRAM).

19. A method for driving a display system, the display system comprising a display device and a computer host, the display device comprising a display panel and a plurality of first memory units, the first memory units storing data used to drive the display panel, the computer host comprising a plurality of second memory units respectively corresponding to the first memory units for receiving and storing display data, the method comprising:
(a) holding data stored in a first memory unit and utilizing data stored in the first memory unit to successively drive the display panel to display a plurality of image frames; and
(b) if display data stored in a second memory unit is different from data stored in the first memory unit, utilizing the display data stored in the second memory unit to update data stored in the first memory unit.

20. The method of claim 19 wherein step (a) further comprises refreshing the first memory unit periodically for holding data stored in the first memory unit.
